(19) United States
(12) Patent Application Publication
(10) Pub. No.: US 2012/0148857 A1
(43) Pub. Date: Jun. 14, 2012

(54) Treated wood and methods of treatment

(76) Inventor: Steve Smith, Piedmont, CA (US)

(21) Appl. No.: 12/928,394

(22) Filed: Dec. 10, 2010

(51) Int. Cl. B05D 1/36; B32B 21/04; C01B 35/04

(52) U.S. Cl. 428/537.1; 423/289; 427/402; 427/419.7

(57) ABSTRACT

A method is taught for of producing a relatively insoluble cation-borate in wood by sequential impregnation of wood with a cation-compound or a borate compound and subsequently the impregnation of the wood with a borate compound or a cation-compound so as to produce a precipitate of cation-borate within the treated wood, without using ammonia or volatile amines.

### CROSS-REFERENCE TO RELATED APPLICATIONS

N/A

### BACKGROUND OF THE INVENTION

1. Field of the Invention

The present invention is in the technical field of preservative treatment of wood, and pertains more particularly to treatment using zinc borate.

2. Description of Related Art

Wood has been a utilitarian substance since the dawn of time for man on earth. However, wood ultimately decays in that it is eaten by small life (e.g., fungi, bacteria, insects), and if not eaten will oxidize and decompose. Thus, it has been a goal of man to help wood resist decay.

Treating wood to improve its resistance to decay, specifically decay caused by small life, has been done for hundreds if not thousands of years. In particularly the last hundred years many new approaches have been tried. Unfortunately, many of the techniques have involved noxious or toxic [to humans; obviously the intent is to render the wood toxic to small life but ideally leave it benign to humans] materials that present hazards during the use of the wood and/or in its ultimate disposal. The methods have not been entirely successful and for example, the materials might be leached from the wood, when containment in the wood for efficacy is desired.

Railroad ties are treated with creosote, and using modern lumber [not the old-growth redwood of 150 years ago], last an average of fifteen years, then have to be replaced. Disposal of the creosote-laden wood is a difficult matter as creosote is broadly toxic and even burning is not a good disposal method, due to environmental issues with the escape of toxic smoke.

A general criterion for water-proofing or water-resistant or water-repellent materials is that they impede the passage of liquid water, impede the passage of ions or molecules dissolved in the water, and are permeable to water vapor, so that excess water that might enter the wood in the liquid form through a shrinkage crack or check, may easily diffuse out later as vapor across a larger surface area and thus not accumulate in the wood to a level potentially hospitable to small life. The underlying scientific principle is that one gram-molecular weight of a substance has a volume in the vapor form of 22.4 liters, and contains Avogadro's number of molecules of that substance, about 6 times ten-to-the 23rd power. Water has a gram-molecular-weight of about 18, and that is about 18 milliliters. The volume ratio is thus about 1200-to-one, which is why water that enters an encapsulated volume through a crack tends to accumulate, since it may not be able to get out as the vapor as easily as it entered as the liquid.

In general, air, moisture, warmth and food are the four things necessary for small life to find wood a hospitable environment. By making the food less palatable if not entirely poisonous, and by reducing the moisture content to a less hospitable level, wood can be made resistant to biodegradation. This general principle is well-known to pest control operators, painting and remodeling contractors, scientists and many other people.

A useful text on borate compounds is The Chemistry of Borates, Part I, Peter H. Kemp, 1956, published by Borax Consolidated Limited, London SW1, England.

In general it is desirable to have a residue of zinc borate in dimensional lumber well in excess of a solubility limit, so the natural aging and incidental leaching of zinc borate out of wood would not readily deplete the wood of its preservative content. It would be desirable to have a residue of zinc borate in wood of something on the order of the ¾% level generally believed to be a necessary and sufficient level for it to be an effective long-term preservative, toxic to insects as well as microscopic small life. Zinc borate is known to be an environmentally friendly preservative, especially by comparison with those containing copper, arsenic or phenols such as are found in pentachlorophenol or creosote.

What is entirely missing in the art at the time of this application is a commercially viable method of creating a natural piece of wood [not plywood or chipboard, but real lumber] containing uniformly distributed a biocidally viable amount of a relatively insoluble borate such as zinc borate within the wood, without introducing corrosive materials or volatile amines or ammonia. Zinc borate (and it is believed this applies to other relatively insoluble borates) is known to dissolve in highly alkaline ammonia and amine solutions, and is known to yield zinc or other borate within the wood, upon impregnation of wood with such a solution and subsequent evaporation of a substantial portion of the ammonia or amine, as is taught in prior art. The process results in a long-term emission from the wood of noxious and toxic residues of amines and/or ammonia, and thus such a process is not commercially viable. The residue of volatile amines or ammonia are to a degree toxic and to a degree noxious, and if detectable at all by odor may cause one to be cited for emission of a “nuisance odor” by agents of a local Air Quality Management District.

So what is critically needed in the art is a process and procedure for preserving wood with zinc borate or other insoluble borate, without the use of ammonia or amine solutions.

### BRIEF SUMMARY OF THE INVENTION

A method is provided for of producing a relatively insoluble cation-borate in wood by sequential impregnation of wood with a cation-compound or a borate compound and subsequently the impregnation of the wood with a borate compound or a cation-compound so as to produce a precipitate of cation-borate within the treated wood, without using ammonia or volatile amines.

### BRIEF DESCRIPTION OF THE SEVERAL VIEWS OF THE DRAWINGS

FIG. 1A illustrates titration of sodium metaborate with zinc salicylate.

FIG. 1B illustrates an unexpected phenomenon observed when taking the data of FIG. 1A.

FIG. 2 illustrates increase in radial dimensions of samples with addition of water in experiments in development of the present invention.

FIG. 3 illustrates increase in tangential dimensions of samples with addition of water in experiments in development of the present invention.

FIG. 4 illustrates increase in axial dimensions of samples with addition of water in experiments in development of the present invention.

FIGS. 5A, 5B and 5C illustrate information regarding solubilities of some of the sodium borates as a function of temperature in the literature.

FIG. 6 illustrates a process according to an embodiment of the present invention, the process comprising two drying steps.

FIG. 7 illustrates a process according to an embodiment of the present invention, the process comprising two immersion treatments and a single drying step.

### DETAILED DESCRIPTION OF THE INVENTION

The new and unique method of treatment taught in the application consists of a zinc borate impregnation process preferably co-resulting with the deposition of additional biocidal materials, or alternatively followed by an additional impregnation with one or more other biocidal materials such as disodium octaborate [Tim-Bor, trademark of U.S. Borax], and then a treatment with a water-repellent polymer such as MultiWoodPrime™ [Smith & Co.] in order to seal the comparatively more soluble materials in the wood so they will remain in the wood and resist leaching by rain or ground-water. This same method may be used on wood windows or doors, and here the MultiWoodPrime offers an additional advantage of chemically bonding a finish [topcoat] to the wood, so that painted or clear-coated wood will have a longer life.

The methods in embodiments of the present invention provide a practical means of preparing the relatively insoluble borates such as zinc borate in-situ in wood that does not produce corrosive residues or harmful byproducts, and results in an environmentally friendly preservative-treated wood.

Referring to the cation of the resulting borate to be created within the wood as the cation, is it generally desirable that the cation be one which produces a relatively insoluble borate upon reaction with an alkali borate, is environmentally friendly and relatively toxic to the specific small life of fungi, bacteria and insects which may attack wood (wood-destroying organisms and/or their symbiotes). Zinc and boron are both toxic to fungi, thus it is natural to focus on zinc borate. Cations toxic to bacteria or soluble carrier-anions of the cation in embodiments of this invention, (such as salicylate, glycolate, etc.), are also desirable, to kill the symbiotic bacterial in the guts of termites and thus the termites, by an additional mechanism than direct borate-poisoning of the insect. Beetles may be similarly addressed. Silver is a known bactericidal cation, but is relatively expensive. The CRC handbook lists silver borate as “very slightly soluble”, suggesting that it would be a viable addition at very low levels to the formulation in some embodiments of the present invention. The aqueous solubility of silver borate at 10 C has been measured as 0.84%. Silver is known to be efficacious against small life at very low concentration, and has been used as jewelry worn next to the skin and in silver-amalgam tooth-fillings for a long time, thus also meets the criterion for environmental friendliness, while maintaining a persistent presence in wood. As for its use in the instant invention in a manner similar to or in conjunction with zinc, the CRC handbook shows that the salicylate, tartrate and lactate of silver all have adequate solubility for use in the manner to be disclosed.

In a preferred embodiment borate of zinc is used as the most-preferred implementation for combined reasons of a long history of social acceptance of zinc, low cost, biological efficacy, existence of salts of adequate solubility and zinc-anions compatible with the end-use, and the low toxicity of zinc to both plants and mammals, including humans. Any other cation may of course be evaluated in this means and, e.g., silver, iron, etc. may be used, although zinc is preferred.

There are little-known zinc salts of organic acids that can be used in conjunction with certain borates, and new and unexpected benefits may be realized in addition to the attainment of zinc-borate-impregnated wood. A solid wood element, not a composite, can be sequentially impregnated with a zinc compound and a borate compound, in either order, and the result is zinc borate impregnated wood, and the zinc borate can be at a biocidally effective level, for ground-contact exposure even as much as about ¾% or more.

Zinc salicylate or zinc lactate, glycolate or other organozinc compounds or mixtures thereof, of adequate water solubility (at least a few percent, as is discussed below) can be used where the resulting anion will actually improve the wood's resistance to fungi [sodium benzoate is a mild food-grade preservative, sodium salicylate is believed to have similar properties] without being corrosive to the wood or metal e.g., brass, an alloy of copper and zinc, or zinc itself [often die-cast as decorative hardware] fastenings that might be used with the wood. The salicylate, lactate and glycolate, for example, have an extra hydroxyl group on the anion, and this aids solubility compared to anions that do not, e.g., benzoate. Other anions with polar groups such as extra hydroxyls, ketone or even the less efficacious methoxy groups would be more soluble than those without, thus a wide variety of anions may be used to best suit manufacturing and application requirements.

Since extremes of acid or alkaline pH may degrade metals or wood respectively, the inventor believes that the resulting wood should be comparable in pH to natural wood, whose pH appears near seven by test of damp wood with Hydrion pH test-paper. It would be an added benefit if the wood tended to be slightly alkaline, perhaps around seven to eight, as that would tend to inhibit steel fastener corrosion. Extremes of acidity as about two to three will dissolve zinc borate, probably making a zinc salt of the acid and boric acid. Extremes of pH above nine will dissolve zinc borate, to impregnate wood with an ammonia or amine-complexed solution of zinc borate. It is preferable that there be no residual volatile amines or ammonia, as such material would have a noxious odor in addition to violating Air Quality Management District regulations for emissions of volatiles and odorous substances from such treated wood, without extraordinary vacuum degassing or other deodorizing treatments.

The inventor has found precipitated zinc borate to be distributed in the form of very small crystals. Zinc borate formed in the inventor's laboratory by mixing solutions of zinc salicylate and a sodium, potassium or lithium borate salt appear as a very fine precipitate, almost colloidal in nature. In performing this experiment by adding the zinc salicylate to the sodium metaborate it was noted that the precipitate did not form immediately, but rather over some seconds to tens of seconds. Thus, the particular properties of the reactants, their particular combination, pH, temperature or other properties of the system may be able to influence the course of the precipitation reaction within the wood, and the compositional distribution of the resultant zinc borate within the wood. It is believed that the delayed reaction of the zinc borate precipitate is due to the solubility of the zinc borate in the initially alkaline solution of sodium metaborate [over pH 9] and that only when a substantial molar portion of zinc salt was introduced did the precipitate begin to form. This is borne out by titration experiments to be described later.

The initial drying treatment of the wood before the inventive impregnation process may be varied according to the wood species, and the details of the zinc borate treatment process to be described, as well as the particular application. Any drying between some or all of the treatment steps may likewise be varied. A final drying treatment would be usual, typically to 19% moisture content for dimensional construction lumber. The 19% number resulting from kiln drying has been found by the construction industry to reduce checking, or wood cracks, due to fast drying and attendant wood shrinkage, and to leave the wood slightly soft and thus easier for a carpenter to drive nails into, and further to minimize splitting from such nailing. Wood that is easy to nail reduces construction labor costs. For fine millwork, the wood is usually dried to less than 10% moisture content. Excessive drying of wood is known to produce warping and may raise the grain, requiring sanding before painting. Thus, a drying procedure appropriate to the manufacture of millwork may be superimposed on the solution-treatment-and-drying requirements in embodiments of the process of the invention. Generally, the treatment of millwork requires a control of wood moisture content through the fabrication, treatment, assembly and painting process. There is no difficulty in wood treatment with aqueous solutions and subsequent drying to less than the initial wood weight, about equal to or even more than the initial wood weight using either ambient-temperature or warm moving air.

Repeated drying and impregnating with the zinc salicylate or other, or different zinc or boron compounds or mixtures thereof, to produce wood with varying amounts of zinc borate, zinc orthoborate, metaborate, etc. may be used It is preferable to have only one intermediate drying step, for economic reasons. It is more preferable to have no intermediate drying, for economic reasons. This can be accomplished for wood used in construction, railroad ties, or the like. Fine millwork, of course, needs to be dried to an environmental-equilibrium moisture content before assembly-gluing and/or painting.

It is not an object of this invention to mix pre-made zinc borate with composites [e.g., chipboard, oriented-strand-board [OSB], particleboard, even plywood]. It is an object of this invention to produce a log or piece of dimensional lumber that is ready to fabricate into a door or railroad tie or other article of commerce, or already fabricated as a wood product such as millwork, treated by a process according to the invention process and as a result containing in itself an effective amount of zinc borate. It is noteworthy that painted millwork such as windows, doors or cabinetry require a much lesser amount of the relatively insoluble borate than wood in continuous ground contact. Nevertheless, the targeted effective level should be several times the water-saturation level of about 900 ppm for zinc borate in the moisture-content of the wood. The invention in various embodiments is a practical means of creating several thousand ppm of, for example zinc borate in the moisture content of the wood, as an effective level in painted millwork that will never be in direct ground-contact.

This process [successive liquid impregnations] could be applied to the veneers of plywood also, and the result would be a preservative-treated plywood sheet, with said preservative uniformly distributed throughout the volume of said plywood sheet. Application of controlled amounts of liquid to flat surfaces such as wood veneers can easily be accomplished

The resulting lumber could contain in addition other materials having a biocidally effective degree of water-solubility, such as (by way of non-limiting example) an excess of soluble borate compound [such as sodium borate, tetraborate or octaborate, for example] because the soluble borate migrates within the wood. It is believed that the soluble borate or other soluble material(s) is to some degree dissolved in the water of hydration of wood, and offers an additional degree of protection by migrating to open cracks or checks as they may develop.

It is a further and highly desirable object of this invention, but not particularly an absolute requirement, that the resulting anion by-products of the reaction which produces the zinc borate have some additional biocidal qualities. The advantageous principle is that a combination of different biocides, even at lesser levels, can be more effective than any single biocide even at a higher level. These two principles, the additional biocidal quality of the cation's anion in addition to the borate anion, and the combination-therapy principle of a multiplicity of biocides for a single organism, is non-obvious, as prior art does not show these principles, and there are no such products in the marketplace of aqueous-preservative or solvent-borne preservative-treated-wood and preservative-treatment products. Even the common and benign organic compound glycerin is known to have antifungal properties, and yet the possibility of combination-therapy with glycerin is not practiced. Even in the borate-glycol solutions, it is only the borate that is considered an active preservative, while the ethylene glycol, long-known in folklore as having antifungal properties, is not represented as such in that product, nor is any idea of combination-therapy promoted. Many biocides are recognized by the United States Food and Drug Administration (FDA) as being safe for addition to food products as food-preservatives, and would thus be considered environmentally friendly as wood preservatives These particular anions, as for example the benzoate and propionate, are thus candidate anions for zinc salts of the instant invention, subject to meeting other criteria such as solubility at the process temperature.

The wood ultimately should discourage attack by insects as well as small life in particular. It is believed that bacteria and yeasts also cooperate in the degradation of wood, and insects such as termites are known to depend upon the symbiotic bacterial species in their guts, thus broad-spectrum biocidal qualities would be desirable. It has been particularly found that a complex mixture of microbes exist in the gut of the termite, and are essential to the termites' ability to digest the wood it eats. Other insects such as powder-post beetles are likewise believed to contain symbiotic microbes in their guts, in order to digest the cellulosic and/or lignin compounds which constitute wood. It is therefore desirable that a multiplicity of biocides and mechanisms be present to effectively kill a broad spectrum of both bacterial and fungi; it is well-known that some fungal species are much more resistant than others to the common sodium borate preservatives.

In order to keep comparatively soluble materials such as a borate salt or even the zinc borate itself within the wood from being leached out by recurring water exposure [e. g., railroad ties] the treated wood can be impregnated by dipping, for instance, with some water-repellent product or a product which allows water vapor to pass while impeding the passage of water-soluble salts. By way of non-limiting example, suitable materials include Clear Penetrating Epoxy Sealer™, also known as MultiWoodPrime™ [Smith & Co., Richmond, Calif.]. Reference material is available at the web sites www.smithandcompany.org/mprime/, www.woodrestoration.com www.smithandcompany.org, and http://www.lignu.com/lignu/tech_info/tech_info.php. Suitable materials further include a water-resistant styrene-butadiene copolymer having low water-vapor diffusion, such as the latex DL313NA, made by Dow.

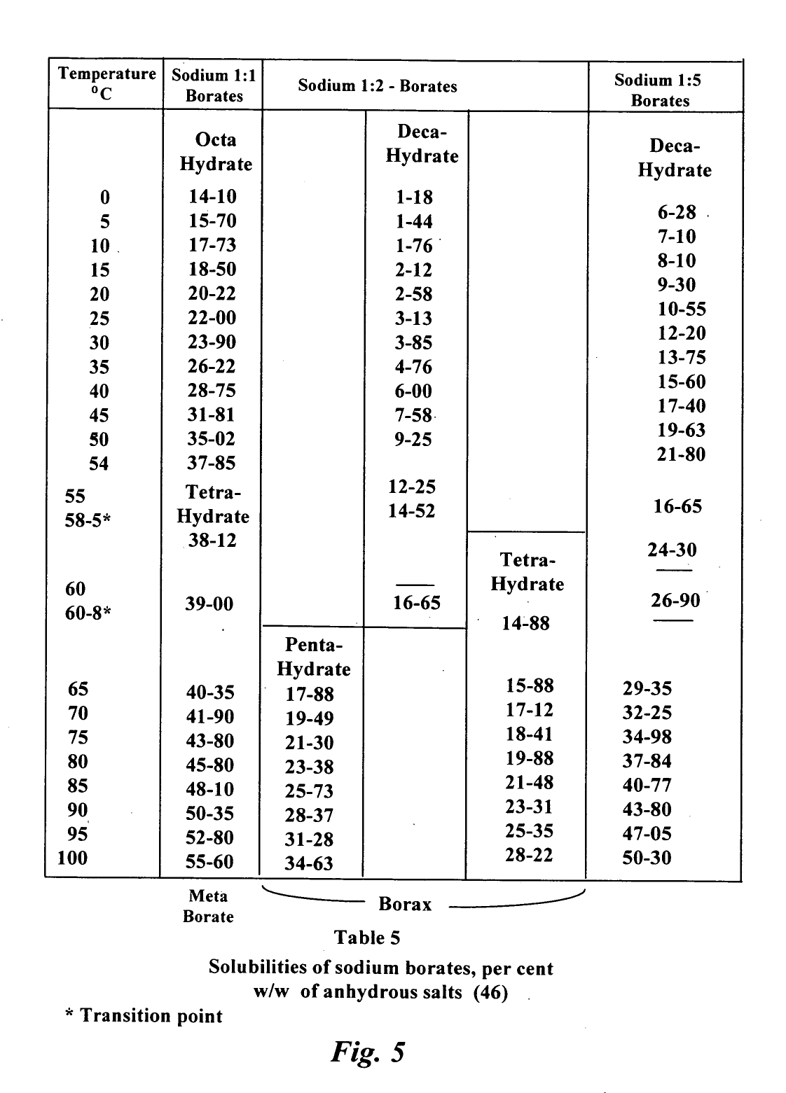

Sodium metaborate and octaborate are much more soluble than the tetraborate, for example, but in water of an appropriate temperature, all have adequate solubility. Information regarding solubilities of some of the sodium borates as a function of temperature is to be found in is included in this application as FIGS. 5A, 5B and 5C.

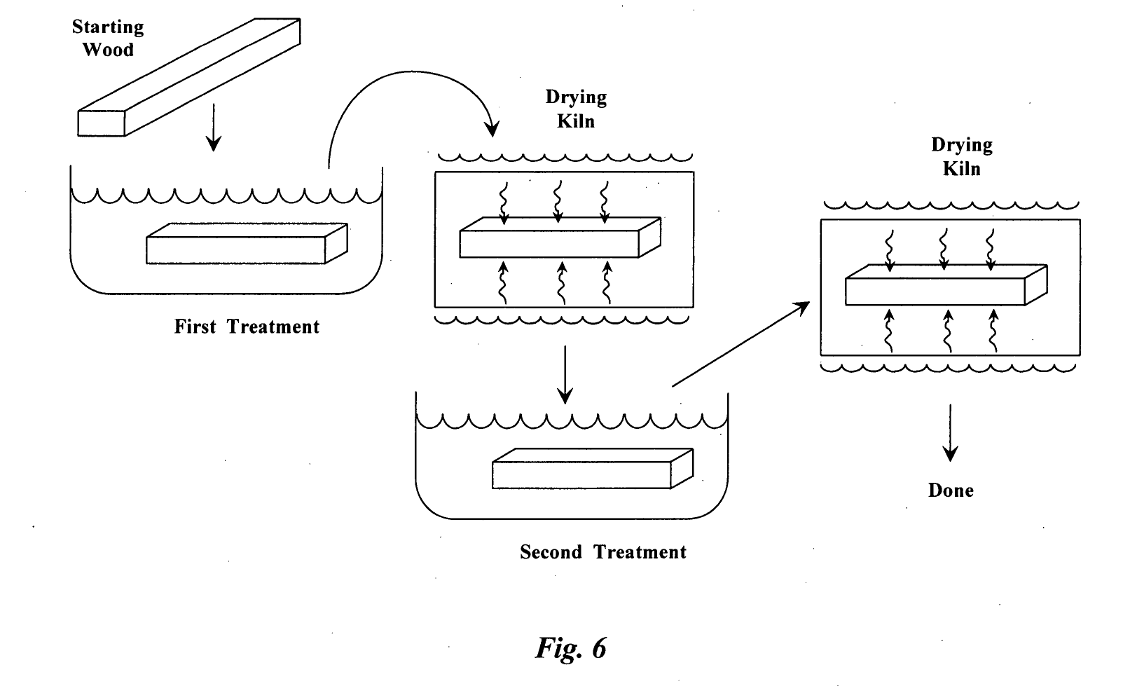

The process in one embodiment of the invention consists of starting with wood dry enough that it can absorb an effective amount of a first aqueous solution, then allowing or causing the wood to lose by evaporation [i.e., drying] enough water that it can absorb an effective amount of a second solution, the sequence creating a relatively insoluble borate dispersed as microscopic crystals within the wood, and a final drying to such moisture level as may be preferable for the ultimate article of commerce, or drying to such moisture content as may be appropriate for a subsequent treatment with a liquid-water-repellent treatment as previously described. The process in one embodiment comprising two drying steps is illustrated in FIG. 6

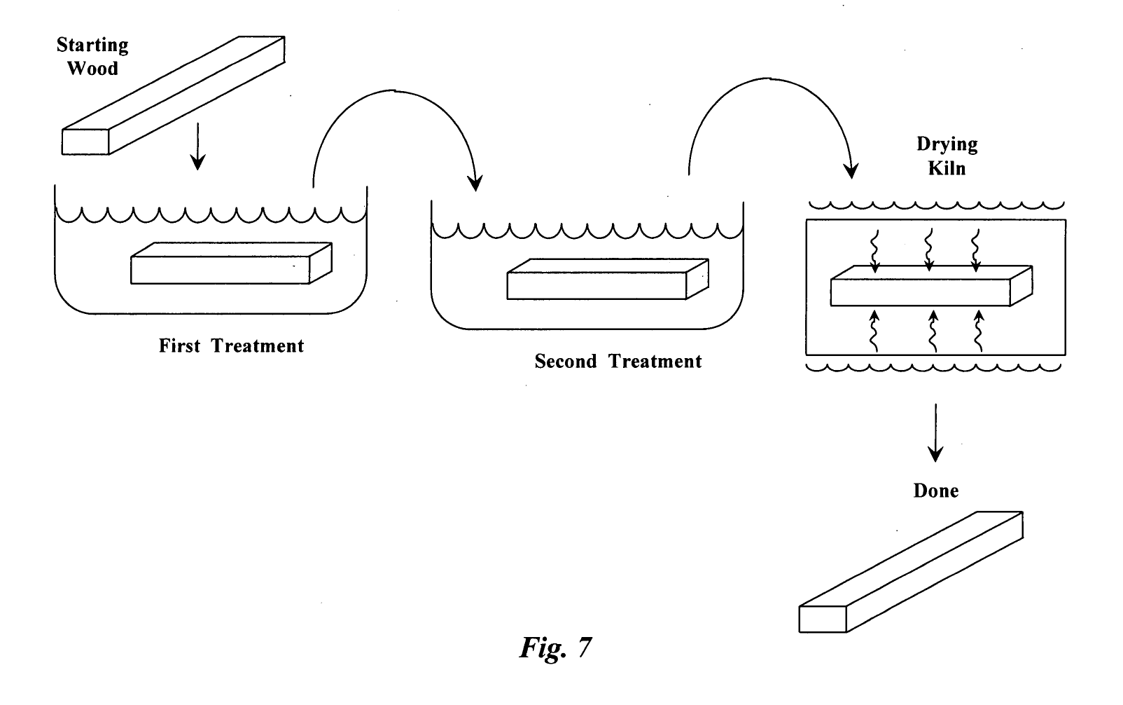

It is possible to treat wood with a controlled amount (as, for example, 75% or less) of its moisture capacity with a first solution, as for example a 0.1 molar solution of a zinc salt or salts, and then the remaining 25% or less of capacity with a borate salt of appropriate molar concentration. The process in an embodiment comprising two immersion treatments and a single drying step is illustrated in FIG. 7

The first solution contains for example zinc salicylate or zinc lactate or glycolate or a mixture thereof, or other zinc anion noncorrosive-to-brass-for-example, since brass is used in much door hardware. For example, one could use the propionic acid salt of zinc, namely zinc propionate. If used in excess it would leave an additional residue of zinc propionate, which would be expected to have a beneficial preservative effect, as calcium propionate is used as a preservative in food to retard spoilage. The overall solubility of an anion or anion combination need to be considered in the selection of anions for the cation of interest [e.g., zinc]; the glycolate or glycolate/salicylate combination is seen to be advantageous compared to others such as the benzoate.

The second solution contains a soluble borate, such as boric acid or sodium borate, metaborate, diborate, tetraborate [“borax] or octaborate [Tim-Bor™] or mixture thereof, as well as the lithium, potassium, rubidium or cesium salts or mixtures of any or all of these.

The reason for using the preferred salicylic, glycolic or lactic acid salt or mixtures is that when, for example, zinc salicylate reacts with sodium borate it creates sodium salicylate, a material with biocidal properties. Similarly zinc glycolate is a preferred material, and its solubility is over five percent in water. See the included table of solubilities. Using zinc acetate or chloride leaves sodium chloride or sodium acetate [corrosive to iron or brass hardware mounted on the door] residue in the door. Similarly, if using acid borates instead of a soluble salt such as sodium, the reaction with zinc chloride leaves hydrochloric acid residue in the wood. Similarly zinc acetate gives acetic acid residue, odor of vinegar and corrosive to common door hardware metals. In contrast, the salicylate and other organic acids may be used to make zinc salts which, when impregnated into the wood, leave a benign residual salt, or even one with additional biocidal properties.

The zinc compound must be soluble enough that by most preferably only one water soaking-and-drying cycles enough zinc compound may be introduced dissolved in the water-of-hydration of the cellulosic fraction of the wood and in the additional free-space of the wood, that is to say in the water capacity of the wood, that there will be enough zinc there to react with the one or more impregnations of water containing a dissolved borate salt, to provide an effective amount of zinc borate. That maximum cellulosic moisture content is known as the fiber-saturation point, and is the point at which further water absorption does not produce physical swelling. Water above that level is free water, and dissolves further zinc or boron salts. This is shown in Example 12 described below. Depending on the wood species and the allowable drying between impregnation cycles, one may design a deterministic and particular process. It is usual to begin the treatment of dimensional lumber cut from a log with a first drying process, typically kiln-drying, to remove the natural water contained in the living tree as well as the low-molecular-weight terpene volatiles such as turpentine, as these reduce the efficacy of a subsequent water-impregnation process. Following is a listing of candidate zinc salts with the properties found in the CRC handbook, 65^{th} edition, and their stated solubilities at various temperatures, and molecular weights. The Name in each case is followed by CRC listed solubilities at stated temperatures, Molecular weight, and Molarity of saturated solution.

| | | |
|---|---|---|
| Zinc benzoate, 2.46 g/100 ml @ 20 C., 0.36 g/100 ml@ 10 C., | M.W. 308, | mol/L 0.0117 |
| Zinc butyrate dihydrate,10.7 g/100 ml @ 16 C. | M.W. 277 | mol/L 0.386 |
| Zinc citrate dihydrate, “slightly soluble” 0.15 g/100 ml, 10 C. | M.W. 610 | mol/L 0.00246 |
| Zinc formate (dihydrate), 5.2 g/100 ml @ 20 C. | M.W. 191 | mol/L 0.272 |
| Zinc glycolate 4.4 g/100 ml@10 C. | M.W. 215 | mol/L 0.205 |
| Zinc d-lactate dihydrate, 5.7 g/100 ml @ 15 C., 5.9 g/100 ml@10 C. | M.W. 279 | mol/L 0.2114 |
| Zinc dl-lactate trihydrate, 1.67 g/100 ml @ 10.6 C. (illogical) | M.W. 297 | |
| Zinc malate 1.4 g/100 ml@16 C. | M.W. 227 | mol/L 0.071 |
| Zinc mandelate 0.38 g/100 ml@14 C. | M.W. 367 | mol/L 0.010 |
| Zinc phenol-sulfonate octahydrate [PSO], 62.5 g/100 ml (temp not stated) | M.W. 556 | mol/L 1.12 |
| Zinc propionate, [unknown, but considering the gradiently increasing | M.W. 249 | mol/L 0.8 est. |
| solubility of valerate and butyrate, it should have solubility in | | |
| excess of ten grams per 100 ml, perhaps 20 g/100 ml.] | | |
| Zinc Salicylate, 5 g/100 ml @ 20 C. 3.9 g/100 ml@10 C. | M.W. 394 | mol/L 0.10 |
| Zinc Valerate dihydrate, 2.6 g/100 ml @ 24-25 C. | M.W. 304 | mol/L 0.085 |

One does not have to put all the zinc borate in at once, although the fewer impregnation and drying cycles, the more economically viable is the process. One can develop a zinc borate concentration incrementally. One could impregnate with a small amount of zinc salt, then enough borate to react with that, then another zinc mpregnation, then another borate treatment, building up the zinc borate level. This is less economically attractive than a single zinc-salt impregnation and a single borate-salt impregnation. There would need to be some compelling advantage to doing it this way, to outweigh the economic disadvantage. One such possible advantage is the ability to produce varying zinc borate compositions within the wood. This may give an additional biocidal quality above and beyond that of a single zinc borate stochiometry.

Zinc borate itself may have a varying composition, and an excess of zinc may discourage one life form while an excess of boron may discourage another, thus there may be a synergistic effect from a combination of zinc borate of two or more different chemical compositions. One could therefore do a first impregnation with zinc salt, then a second impregnation with borate to give a calculated excess of boron, and then a third impregnation with zinc salt such as to precipitate a different chemical composition of zinc borate. The result of this would be that the wood would contain zinc borate of at least two different zinc-boron ratios. The reverse sequence (borate-zinc-borate) could also be done.

Concerning the basic sequence of two impregnations with two reactants in one-order or another, a third impregnation could be done to add additional soluble biocidal materials, in the following manner: First impregnation, boric acid; Second, zinc salicylate, nearly a stochiometric amount [correct quantity of one chemical to react with all of the other, leaving theoretically no excess of either and a certain intended stochiometric composition of zinc borate]; third impregnation, disodium octaborate, the most effective of the borate preservatives according to the producer U.S. Borax. [The pH must not be sufficiently alkaline as to solubilize the zinc borate. One may use the lithium (borate) salt rather than the potassium to obtain a less alkaline result.] That results in wood containing zinc borate, salicylic acid and disodium octaborate, which will have biocidal properties greater than any separate ingredient.

Other materials could be in the first, second or later aqueous impregnation, such as capsaicin, another biocidal deterrent, particularly for insects. The American Wood Products Association (AWPA) has standards such as UCC3 and UCC4, which require insect as well as fungal resistance. The dislike of insects for capsaicin is well-known.

### Application to Metal Fasteners

The instant invention of combining two ingredients to make zinc borate inside wood can be applied to other areas of wood treatment than aqueous impregnation. There are already nails coated with a glue; upon driving in the nail it glues itself in, giving additional pull-out strength.

The inventor contemplates applying this invention to nails, to give rot resistance when nailing wood. It is observable that when a nail penetrates wood, the hole in the wood is not exactly round, but rather is spindle-shaped, with slight triangular openings between the wood and the nail, on opposite sides of the nail and parallel to the grain. It is observable that rot tends to be more prevalent where nails penetrate wood, since moisture and fungal spores are introduced inside wood by such openings and rot tends to follow the grain of wood.

The inventor conceives a nail coated with a first binder containing a borate salt, and a second binder containing zinc salicylate or other anion not corrosive to iron or zinc some nails are galvanized] or salt thereof, in either order. The binder could be soluble in water, or could disintegrate on prolonged water exposure, or could simply be permeable to moisture-mediated migration of its contained salts. The nails would be driven into wood such as decks outside houses, where there is negligible protection from ambient rain and weathering. When installed, the first water exposure could slowly dissolve the outer binder and release the first compound which would migrate into the wood. With further passage of time the inner binder would break down enough to allow the second salt to migrate into the wood, creating zinc borate in a concentrated zone near the nail penetration of the wood, thus protecting the wood region most prone to rot. Since the dissolution of a binder coating could loosen the grip of the nail in the wood, the binder coating need not dissolve but merely be permeable to water and the soluble salts.

### EXAMPLES

By way of examples of application as well as showing the underlying science of the present invention, a series of experiments with results, as examples of application of the technology is presented below. The overall logic and structure of the following examples is, in the numerical order of the examples:

1. Show how to make a candidate zinc salt.
2. Show how to use the zinc salt to make zinc borate of some stochiometry.
3. Show how to determine if addition order makes a difference.
4. Show by pH behavior in the titration of a borate with a zinc salt that excess zinc salt does not give the expected pH, thereby proving that buffering is taking place.
a. Measure the pH of City Chemical zinc borate, and compare with the pH of the instant borate.
b. Note that the pH of 0.1 Molar zinc salicylate is about 4.1.
c. Inspect the titration data.
d. The buffering premise logically follows.
   Examples 5, 6, 7 and 8 show the process and lay the groundwork for example 9.
   9. Show the chemical reaction makes zinc borate inside the wood
   Examples 10 and 11: Show wood impregnated with the new process
   12. Show the treated wood has dimensional stability comparable to untreated wood.

### Example 1

### Making Organozinc Salts

The organozinc salts have been found to be easily made by introducing zinc oxide and the organic acid in the stochiometric proportions into water and bringing to a boil. In a few minutes to at most an hour, the solution becomes clear, if sufficiently dilute that one does not exceed the solubility limits of the salt to be formed or the acid itself. Zinc sorbate, for example, had so little solubility even in hot water that it was not practical to make zinc sorbate by this method.

Zinc mandelate was not fully made with 0.01 mol (0.81 grams) zinc oxide and 0.02 mol (3.04 grams) mandelic acid in 700 ml boiling water, but the solution promptly clarified when the water was increased to 800 ml. The flask was allowed to cool at ambient conditions and sit overnight. In the morning a fine dusting of crystals was observed. Over the next few days more crystals developed. The flask was remixed several times daily, to make more fine crystals to promote seeding of the supersaturated solution. Zinc malate exhibited similar behavior. A mixture of salicylic and glycolic acids (as suggested by U.S. Pat. No. 5,482,710), by contrast, promptly crystallized overnight, and by the next morning the supersaturated solution had deposited much zinc salicylate/glycolate.

A portion of the saturated solution of zinc malate was evaporated to dryness in a 70 C oven and weighed, and dried further in a 125 C oven. The first drying did not appear to dehydrate the salt, where the second one did. Knowing the molecular weight of the product, it was possible to calculate how many moles of water were hydrated. It was thus possible to calculate the molar content of a saturated solution of the particular zinc salt, and thus to determine if is was sufficiently soluble at a low but possible processing temperature for an unheated preservative-treatment facility. In this manner the laboratory-measurement data in the prior solubility table was obtained. In the particular case of zinc malate (M. W. 197), this was made from 0.15 mole malic acid (20.1 grams) and 0.15 mole zinc oxide (12.15 grams) in about 300 mL water, approximately a 0.5 molar solution. It clarified with boiling. Ten grams of the clear solution was dried overnight in a 70 C oven. It did not crystallize but rather dried to an amorphous glass of net weight 1.05 grams. This was further dried at 125 C to a brittle white foam of net weight 0.91 grams. Assuming this to be the anhydrous salt, 0.91/197=0.00463 mole, and thus 1.05/0.00463=227, the apparent molecular weight before dehydration. This is 30 more than the molecular weight of the presumed anhydrous salt. Water has a molecular weight of 18. This implies it is the 1.5 hydrate. Within the limits of experimental error it may be the monohydrate or the dihydrate.

The 0.5 molar solution of zinc malate remained clear for two days at 10C. The anhydrous foamed salt was crushed and added back to the solution, as crystallization seeding. Small crystals continued to form as the flask was stirred daily for a week. Finally, no further crystal growth was apparent. A portion was evaporated and weighted and the solids content of the saturated solution thus determined to be 2.9 grams/100 ml, or 0.133 molar.

Upon further standing for two weeks in ambient conditions of about 10-17 C, further crystal growth or rearrangement was apparent, and the laboratory temperature had varied recently, suggesting the earlier solution was still supersaturated. Accordingly, 20 gram portions of the lactate, glycolate and malate were evaporated to dryness overnight in a 70 C oven, the residues weighed, and transferred to a 125 C oven for further drying to the anhydrous salts. The resulting data is that presented in the Solubility Table.

### Example 2

### Making Zinc Borate from Zinc Salicylate and Sodium Metaborate

About 4 millimoles of zinc salicylate as 40 grams of a 0.1 molar solution was placed in a 200 ml beaker with a stirring magnet on a stirring plate. About 8 millimoles as 40 grams of a 0.2 molar solution of sodium metaborate (Na₂O)(B₂O₃) was added in increments of about 1-2 ml, with good mixing. After each incremental addition, the solution was allowed to stand without mixing until the zinc borate precipitate had settled to show a clear upper layer. About 2 ml was withdrawn and placed in a 3 ml test tube. A drop or two of the borate solution was added. If a precipitate was visible, the reaction was judged to have not gone to completion. The contents of the test tube were returned to the beaker and the procedure continued.

The amount of visible precipitate from this test steadily decreased as more of the borate solution was used up. The last borate additions were about 1 ml each, and for the last addition the amount of precipitate was only barely visible. It was concluded that this procedure, beginning with four millimoles of zinc and eight millimoles of (B₂O₃), makes (ZnO) (B₂O₃)₂.

### Example 3

### Does the Order of Addition Make a Difference?

30 grams of 0.1 molar zinc salicylate was added to 30 grams of 0.2 molar sodium metaborate, giving a molar ratio of the reactants of approximately 1:2 (ignoring density differences), slowly with good mixing.

In a second parallel experiment, 30 grams of 0.2 molar sodium metaborate was added to 30 grams of 0.1 molar zinc salicylate, giving a molar ratio of the reactants of approximately 2:1 (ignoring density differences), slowly with good mixing. These two experiments should yield about the same result, if order of addition does not matter.

Both the precipitates were washed with a total of 450 ml of water in about six portions, by allowing the precipitate to settle to about half the volume of the solution and drawing off the supernatant phase, and adding a portion of water, mixing well, and allowing to stand six hours until the precipitate had settled.

The solubility of the zinc borate furnished by City Chemical was measured previously at about 0.09% in water at ambient temperature (10-15 C). Its exact formula is unknown. Its solubility was assumed comparable to the zinc borate made here. The wash-water is thus calculated to have dissolved 0.40 grams of zinc borate. The washed precipitates were dried to constant weight in a 70 C oven. The dried borate→zinc residue weighed 0.35 grams. The dried zinc→borate residue weighed 0.30 grams.

Thus, the total amount of zinc borate made by forward or reverse addition of these stochiometric proportions was about 0.70 to 0.75 grams, essentially the same within experimental error limits. The pH of a saturated solution of zinc borate as furnished by City Chemical was measured at 6.7. The pH of a saturated solution of zinc borate made by the process of this example and washed as described herein was measured at 6.7. The expected amount of zinc borate of formula (ZnO) (B₂O₃)₂, molecular weight 221, was three millimoles, but this undoubtedly contains some water of hydration. 0.725 grams average/0.003 moles=241 effective molecular weight. The difference between 241 and 221 is 20, very close to the molecular weight of one water. It was concluded that this material is likely zinc borate monohydrate, made by either order of addition of these stochiometric proportions, at about ten to fifteen degrees Centigrade.

### Example 4

### Demonstration of Buffering by Titration of Sodium Metaborate with Zinc Salicylate

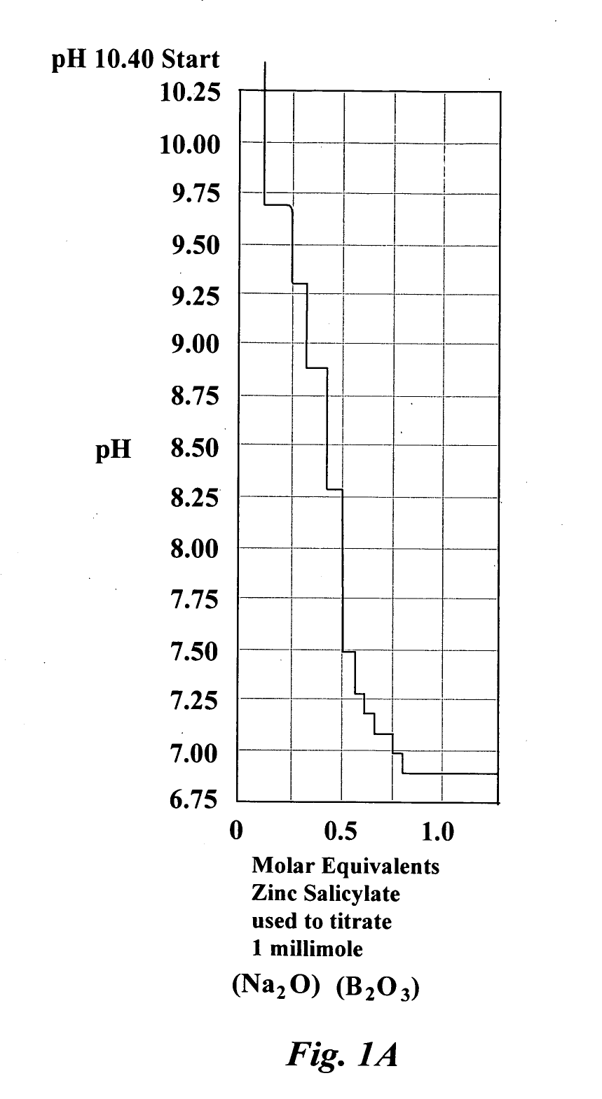

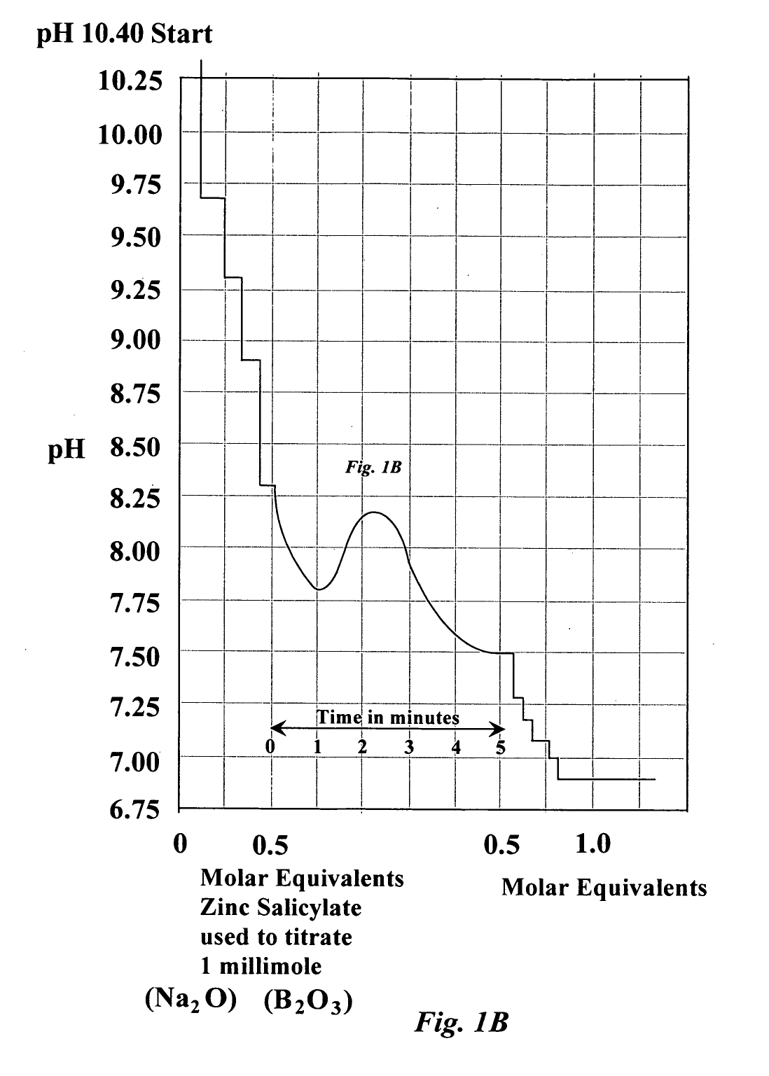

Increments of zinc salicylate were added with good stirring to a sodium metaborate solution, and the pH measured. Time was allowed for the pH reading to equilibrate after each addition. This typically took ten to thirty seconds, and increased noticeably with further additions. An Ion-Sensitive FET pH meter was used. The meter was calibrated before and after each measurement series with pH 7.0 buffer solution, and the readings corrected for any meter drift observed. The pH measurements were graphed. One series is shown in FIG. 1A. This data was taken with a pH meter and a magnetic stirrer in a 100 mL beaker containing 0.001 mole of sodium metaborate in 10 mL of water. A solution of 0.1 molar zinc salicylate was added from a calibrated burette in increments.

It was seen in Example 2 that one mole of zinc combines with two moles of borate, judged by diminishing and ultimately cessation of precipitation, to yield one mole of (ZnO) (B₂O₃)₂. With reference to FIG. 1A, it is seen that when about V2 molar equivalent of zinc salicylate has been added to one molar equivalent of sodium metaborate, the pH has dropped to about 7.5. At this point the solution volume is about 15 ml. With the addition of a further 0.5 molar equivalent of zinc salicylate, the solution volume was 20 ml. The pH was now 6.9. The measured pH of 0.1 molar zinc salicylate was found to be 4.1. Five milliliters of a solution of pH 4.1 contains about 10⁻⁴ moles H⁺ per liter times 5/1000=5×10⁻⁷ moles H⁺. Fifteen mL of a solution of pH 7.5 contains 15/1000×10⁻⁷⁵ moles of H⁺, or about 10^{-9.3} moles H⁺. Twenty milliliters of a solution of pH 6.9 contains 20/1000×10^{-6.9} moles of H+, or about 10^{-8.7} moles of H+. Yet, to that 10^{-9.3} moles H⁺ were added about five hundred times as much, and ninety-nine percent of what was added had apparently vanished. This shows that a buffering action is present, an unexpected and useful phenomenon.

FIG. 1B shows an unexpected phenomenon observed when taking the data of FIG. 1A. Over a period of about five minutes the pH was observed to display unusual behavior. With all the prior additions the pH had equilibrated in less than about a minute. At the addition that gave almost the stochiometric proportions the pH was observed to go down, then up, then down again to a lower value, as shown in FIG. 1B. With the addition of a further ten percent of the amount added, a similar but much smaller pH excursion was observed over a period of a few minutes, going from 7.5 to 7.3 to 7.4 to 7.3. A similar titration with potassium metaborate showed a similar anomalous pH fluctuation around 7.5-7.0, as did one with lithium metaborate.

### Example 5

### Saturated Water Capacity of Wood

Three representative pieces of the type of wood meeting the WDMA test standard, measuring 1 9/16 inch by 5 inches were cut 6/10 inch thick in the direction of the grain (axial), equilibrated to ambient humidity at 10 C, and weighed. They were saturated with water to measure the water capacity.

| | | | |
|---|---|---|---|
| Saturated weight | 45.99 | 46.17 | 45.96 |
| Initial weight | 29.33 | 29.70 | 29.33 |
| Net water added | 16.66 | 16.47 | 16.63 |
| Percent water content | 56.5% | 55.5% | 56.7% |
| at saturation | | | |

### Example 6

### Estimation of Wood Absorption of Zinc and Borate Solutions

The zinc salts under consideration may have lesser solubility than the borate salts under consideration. The limiting capacity of the wood for zinc borate whose constituents may be put into the wood in one or two impregnations may be determined mainly by the solubility of the zinc salt in water at the process temperature. It is assumed that such processing may be done with outdoors equipment and in an unheated environment, perhaps as low as ten degrees C. If it is assumed that wood will absorb about fifty percent by weight water, and it is impregnated first with a zinc salt and then with a borate salt to make (ZnO) (B₂O₃)₂, the ZnO part is 81/221, +36.6%. Thus, to impregnate wood to the one percent level (well above the ¾% desirable minimum) with zinc borate, only ned 36% is needed to come from the zinc salt. For 200 grams of wood that may have a capacity of 100 grams of 0.1 molar zinc salicylate solution, that would be 3.93 grams or 0.01 mole of zinc salicylate which provides 0.01 mole of ZnO, which will yield 0.01 mole of (ZnO) (B₂O₃)₂ of molecular weight 221, or about 1.1% by weight zinc borate in the dry-weight 200-gram wood specimen. To obtain the desirable minimum of ¾% zinc borate only 68 grams would be needed of a 0.01 molar solution of zinc salicylate to be absorbed by a first impregnation process.

Using zinc salts of higher solubility than 0.1 molar, impregnation can occur with a much lesser volume of the zinc solution than the water capacity of the wood, and (after allowing sufficient time for the first solution to sufficiently equilibrate its distribution within the wood) then impregnate a borate salt of appropriate solubility to be contained within the second impregnation volume. It is thus possible to eliminate a kiln-drying step between the two impregnations. Zinc lactate is soluble to about six percent, and has a weight of about 298. Thus, it can yield about a 0.2 molar solution. Only fifty grams of zinc lactate solution is required to impregnate 200 grams of wood to yield 0.01 mole of zinc borate (ZnO) (B₂O₃)₂, about 1.1% by weight, well in excess of the ¾% desirable minimum. Zinc glycolate may also be used. As seen from the earlier table of solubilities, its saturated solution is 4.4%, or about 0.2 molar. The second impregnation may contain excess borate. Either impregnation may contain additional biocidal materials, within solubility limits. If excess additional material is introduced, it will not dissolve. That determines a solubility limit. Compatibilities and solubility limits of mixed formulations may be determined in the manner of Example 1.

Viable candidate zinc salts for such an impregnation process are thus seen to include the butyrate, formate, glycolate, lactate, phenol-sulfonate, propionate and salicylate.

The solubilities of sodium borates are significantly higher than most of the exemplary zinc salts, thus a combination process with only a drying step for the natural wood before the impregnations and a drying step after the impregnations is possible. If the final drying were to take place while the wood was in-transit as an article of commerce, or after installation by construction, even a final kiln-drying step might be eliminated. Naturally, if a higher concentration of impregnated zinc borate was desired, or if the water capacity of the wood were significantly less than fifty percent, one could impregnate with a first ingredient, subject the wood to an intermediate kiln-drying step, impregnate with a second salt that produced the desired zinc borate precipitate within the wood and then a final drying to such moisture level as the ultimate article of commerce might require.

### Example 7

### Choosing Candidate Zinc Salts for the Impregnation Process

The concentration of materials may be varied according to the drying process and the amount of water introduced in each step. For example, assume 100 grams of dry-weight wood and a goal to impregnate it with about one gram of zinc borate containing about 36% (ZnO). Assume beginning with sixteen-percent moisture-content wood, as 120 grams total weight of said wood, containing 20 grams of water. Add fifty grams of water, raising the total moisture content of the wood to 70 grams and the percentage moisture content to 70/170 or about 41%. That fifty grams of water must, for doing a single zinc impregnation, contain about 0.36 gram of (ZnO) as some zinc salt. If, based on molecular weights, the salt is about twenty to forty percent (ZnO), this implies that about 1.8 to 0.9 (depending on molecular weight) grams or more of the candidate zinc salt must be soluble in that 50 grams of water. In terms of moles, the candidate zinc salt must provide 0.36/81=0.00445 moles in the 50 mL of water, or about 0.09 molar at the process temperature. From the aforementioned but nonlimiting list of exemplary zinc compounds and assuming a single zinc impregnation, suitable zinc salts are hereby seen to be the salicylate, propionate, PSO, glycolate, lactate, formate, and butyrate, and in warmer water perhaps also the valerate and the malate. Mixtures of these or others may be used, provided that the individual salts are not present beyond their individual solubility limits, as is usually understood in chemistry. In this manner, with consideration to the candidate process conditions and allowable process temperature, candidate zinc salts and mixtures thereof may be chosen.

### Example 8

### Water Gain of Zinc-Salt-Impregnated Wood

A week after Example 5 was done, the three wood specimens of that example were again equilibrated to ambient conditions, and found to weigh slightly more than the first time, another week earlier. It was realized that reference wood specimens had to be weighed along with the experimental specimens, to compensate for the varying environmental conditions in the laboratory. Accordingly, three other reference specimens were re-dried along with six more to be impregnated, and the new ambient weights of all were noted as “Re-dried weight” in the table below.

Six wood specimens were impregnated, three with 0.1 molar zinc salicylate and three with 0.1 molar zinc salicylate/glycolate in the anion ratio of 2.5:1. These were dried for a week to equilibrium with ambient conditions, at 17 C and 57% R. H. Three reference pieces were simultaneously conditioned. In the following table, “Initial weight” means weight a week ago. The purpose of this comparison is to correct the weights of the impregnated dried wood specimens for moisture content due to variations in ambient temperature and humidity. It was expected that all the wood specimens would absorb atmospheric humidity equally. Surprisingly, this turned out to not be the case. If the final zinc-borate-impregnated wood exhibits similar behavior, this process might be found to confer on dimensional lumber the added benefit of dimensional stability by reducing the dimensional change wood normally exhibits with variations in environmental humidity.

### Reference Wood Unimpregnated

| | | | |
|---|---|---|---|
| Initial weight | 28.31 | 29.74 | 30.84 |
| Weight today | 28.78 | 30.21 | 30.84 |
| Change due to environment | +0.47 | +0.47 | +0.54 |

Average of these is 0.49. Use that as correction factor

Impregnated with 0.1M Zinc Salicylate

| | | | |
|---|---|---|---|
| Original weight | 29.33 | 29.70 | 29.33 |
| Re-dried weight | 29.55 | 29.98 | 29.64 |
| Gross Impregnated weight | 44.60 | 44.75 | 45.16 |
| Net solution absorbed (3.6% solids) | 15.05 | 14.77 | 15.52 |
| Calculated impregnated solids | 0.54 | 0.53 | 0.56 |
| Post-impregnation weight today | 29.79 | 30.12 | 29.79 |
| Original weight | 29.33 | 29.70 | 29.33 |
| Correction factor | +0.49 | +0.49 | +0.49 |
| Corrected initial weight | 29.82 | 30.19 | 29.82 |
| Measured impregnated solids | −.03 | −.07 | −.03 |

Impregnated with 0.1 M Zinc Salicylate/Glycolate of a 2.5:1 Anion Molar Ratio

| | | | |
|---|---|---|---|
| Original weight | 28.90 | 28.74 | 29.83 |
| Gross Impregnated weight | 44.58 | 44.41 | 45.33 |
| Net solution absorbed (3.2% solids) | 15.68 | 15.67 | 15.50 |
| Calculated impregnated solids | 0.50 | 0.50 | 0.50 |
| Post-impregnation weight today | 29.46 | 29.31 | 30.39 |
| Original weight | 28.90 | 28.74 | 29.83 |
| Correction factor | +0.49 | +0.49 | +0.49 |
| Corrected initial weight | 29.39 | 29.23 | 30.32 |
| Measured impregnated solids | +.07 | +.08 | +.07 |

These results seem impossible: Adding about a half a gram of solids and seeing essentially no weight gain. The only logical explanation is that evidently the added impregnated solids interferes with the ability of the wood to hydrate atmospheric moisture.

### Example 9

### Evidence of a Chemical Reaction Inside the Wood

One piece of wood as described in Example 5 was impregnated with about fifteen grams of a 0.1 molar zinc salicylate solution, and dried to constant weight. It was then allowed to float in a 0.2 molar sodium metaborate solution, absorbing it by capillary wicking. After six hours the upper surface was damp. Hydrion test paper showed the upper wood surface to be about neutral, but a test of the solution being wicked in showed it to be strongly alkaline, about 10-11pH, evidence of a chemical reaction having taken place inside the wood.

This piece of wood, after the six hours, had increased in weight from an initial 29.7 grams to 42.2 grams, about 75% of its expected water capacity, and the piece still exhibited considerable warping, due to the lower portion being hydrated and swollen, but the upper part much less hydrated. It is believed that impregnation with an excessive quantity of zinc borate creates a thixotropic gel inside the wood that impedes absorption by the second chemical impregnating solution. In contradistinction, see Example 10.

### Example 10

### Treatment of Wood in Two Impregnations with Intermediate and Final Dryings

Three pieces of wood as used in Example 5 were impregnated with a 0.067 molar solution of zinc salicylate. Another three such pieces were impregnated with a 0.067 molar solution of zinc salicylate/glycolate of a 2.5:1 anion molar ratio. Weights were noted. These were all dried to no further weight change, at about 17 C, 50% R. H. They were weighed, and then impregnated with a 0.133 molar solution of sodium metaborate. The metaborate solution itself tested strongly alkaline [blue on Hydrion test paper} but the water that wicked up through the wood tested near neutral [pale orangish on the test paper]. The second impregnation with a 0.133 molar solution of borate was largely complete in an hour and the initial warping of the wood was observed after an hour to have gone. It is noteworthy that the wood impregnates most rapidly to about ½ to ⅔ of its water capacity.

### Example 11

### Treatment of Wood in Two Impregnations with One Final Drying

The water capacity of ambient-conditions-equilibrated wood specimens as described in Example 5, weighing about 29 grams each, were determined by equilibrating three representative pieces to ambient conditions, weighing, saturating by immersion in water overnight, and measuring the weight gain. This was found to be in excess of fifteen grams. The following experiment was therefore designed using a total of fourteen grams of solutions.

Three pieces of ambient-conditions-equilibrated wood specimens as described in Example 5 were placed in zipper-sealed plastic bags with 10 mL of a 0.1 molar solution of zinc salicylate/glycolate with the anion ratio 2.5:1. Equilibration appeared to be complete overnight. A week later, 4 mL of a 0.5 molar solution of sodium metaborate was introduced into each bag, and the bags resealed. By the next day all the free liquid had been absorbed. A few days later, the top and bottom of each piece of wood tested about neutral to Hydrion pH-test paper. Sodium metaborate solution tests strongly alkaline.

These impregnated specimens and three control specimens of initial weights all measured at the same time under laboratory ambient conditions were all placed in an unheated forced-air circulation oven to equilibrate to ambient humidity at about 15 C.

From a later experiment to determine total water capacity and swelling, it was found that the bone-dry weights were typically 25 grams, thus a nominal weight of 29 grams is including about 4 grams water-of-hydration of the cellulose of the wood. The following measurements were taken:

### Control Specimens

Average change of −0.83 grams due to drier new ambient atmospheric conditions on the day of these measurements will be used to correct the weights of the impregnated specimens.

| Initial Weight | Dried Weight | Measured change |
|---|---|---|
| 29.06 | 28.24 | −0.80 |
| 29.92 | 29.08 | −0.84 |
| 30.20 | 29.34 | −0.86 |

### Impregnated Specimens

| | Impregnated, | Corrected | Measured | Expected |
|---|---|---|---|---|
| Initial | dried | weight | change | added |
| 29.86 | 30.28 | 29.47 | −0.39 | +0.58 |
| 29.61 | 30.00 | 9.19 | −0.42 | +0.58 |
| 28.77 | 29.19 | 28.38 | −0.39 | +0.58 |

Representative pieces of this wood were baked at 70 C and ultimately at 100 C and found to be holding several grams of water of hydration; their ultimate dry weights were about 25 grams. The zinc salicylate/glycolate solution is about 3.2% solids by weight, and the sodium metaborate solution is about 6.6% solids by weight.

It is logical to conclude from this evidence that some of the few grams of ambient-conditions water-of-hydration is being displaced by the impregnated materials.

### Example 12

### Dimensional Stability of Treated Wood

The three pieces of treated wood from Example 11 and three representative pieces of untreated wood were dried to no further weight loss at 100C. The initial weights and dimensions were noted. It was observed that in the dry condition, the impregnated pieces had on the average five percent greater volume (due to how they were saw-cut) but only three percent greater weight.

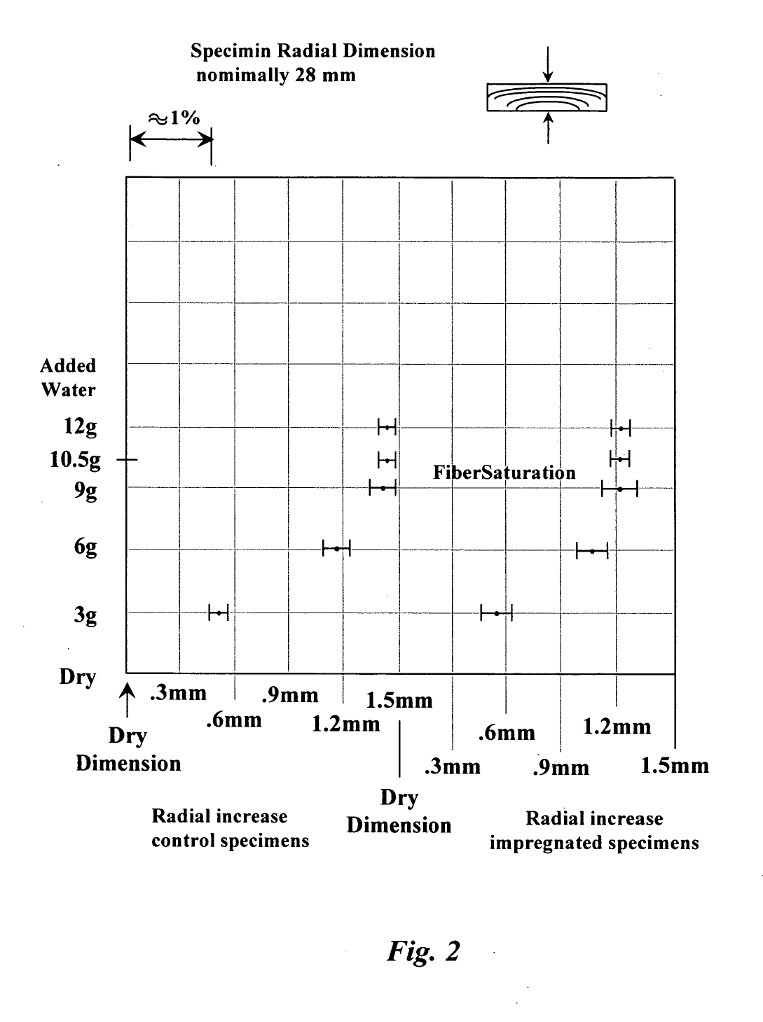

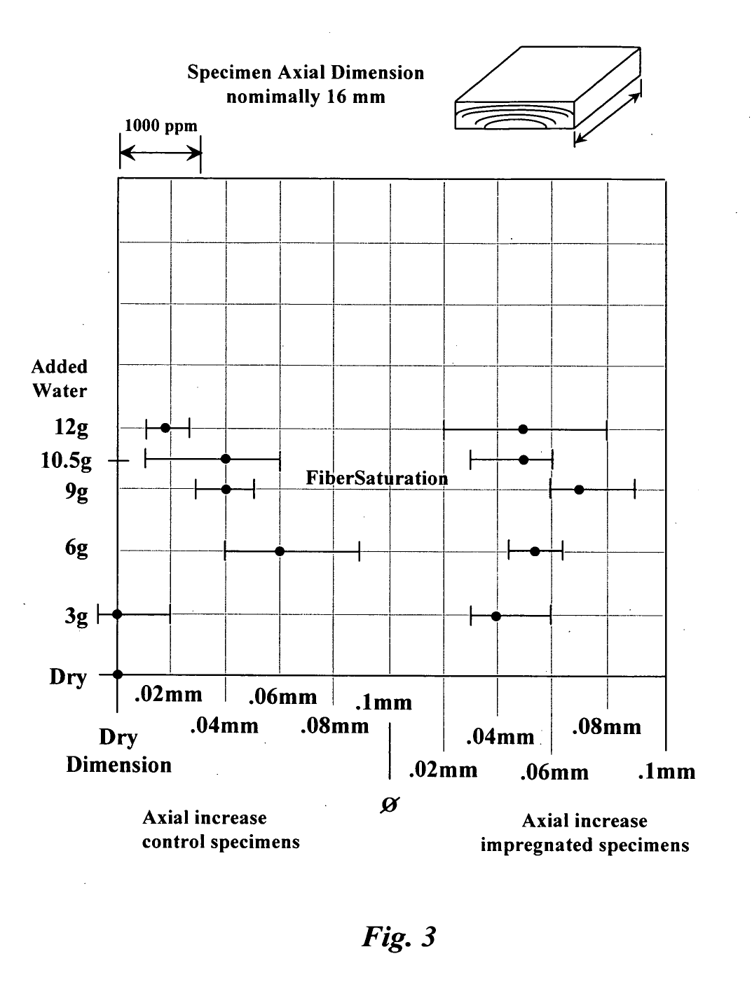

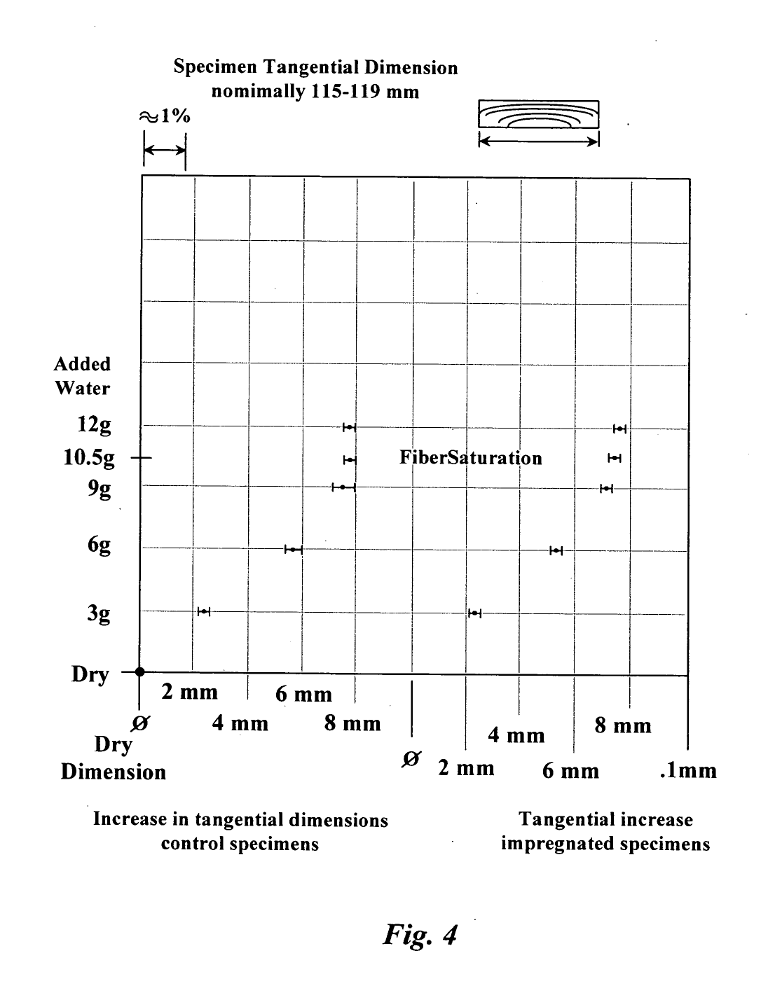

Portions of water were added to each wood specimen and 24 hours allowed for equilibration, stored in zipper-sealed plastic bags. Dimensions were measured after each addition and equilibration cycle. The changes in each of the dimensions (radial, tangential and axial) were noted. These changes were tabulated and presented graphically as FIGS. 2, 3 and 4.

In the range from about 11-23% moisture content, the moisture-related dimensional stability of treated wood in the axial dimension was about 600 ppm, compared to about 1200 ppm for untreated wood. In that moisture range, the tangential stability was about 2.4% versus about 2.8% for untreated wood. It is clear that the treatment process creates wood of comparable to better dimensional stability than untreated wood.

### Example 13

Example 11 was repeated with one mole percent of the zinc salicylate/glycolate solution replaced with two mole percent of silver salicylate (zinc having a valence of two, and silver having a valence of one), to essentially the same physical result.

### Example 14

Example 11 was repeated with fifteen mole percent of the zinc salicylate/glycolate solution replaced with fifteen mole percent of ferrous lactate (zinc having a valence of two, and ferrous iron having a valence of two), to essentially the same physical result.

1. A method of producing a relatively insoluble cation-borate in wood by the sequential impregnation of wood with a cation-compound or a borate compound and subsequently the impregnation of said wood with a borate compound or a cation-compound so as to produce a precipitate of cation-borate within said wood, without using ammonia or volatile amines.

2. The method of claim 1 wherein a drying step is done between the first impregnation and the second impregnation.

3. The method of claim 1 wherein the cation is zinc

4. The method of claim 2 wherein the cation is zinc

5. The zinc borate produced by the method of claim 3.

6. The zinc borate produced by the method of claim 4.

7. The wood/zinc borate composite material produced by the method of claim 3.

8. The wood/zinc borate composite material produced by the method of claim 4.

9. The presence in the composition-of-matter of claim 7 of one or more biocidally effective anions.

10. The presence in the composition-of-matter of claim 8 of one or more biocidally effective anions.

11. The method of claim 1 wherein the cation is silver, or a combination of silver and zinc.

12. The method of claim 2 wherein the cation is silver, or a combination of silver and zinc.

13. The wood/borate composite material produced by the method of claim 9.

14. The wood/borate composite material produced by the method of claim 10.

15. The wood/borate composite material produced by the method of claim 11.

16. The wood/borate composite material produced by the method of claim 12.
